(19) United States
(12) Patent Application Publication
(10) Pub. No.: US 2018/0054359 A1
(43) Pub. Date: Feb. 22, 2018

(54) NETWORK ATTACHED RECONFIGURABLE COMPUTING DEVICE

(71) Applicant: International Business Machines Corporation, Armonk, NY (US)

(72) Inventors: Francois Abel, Rueschlikon (CH); Christoph Hagleitner, Wallisellen (CH); Jagath Weerasinghe, Adliswil (CH)

(21) Appl. No.: 15/242,142

(22) Filed: Aug. 19, 2016

(51) Int. Cl. H04L 12/24; H04L 29/12; G06F 9/44

(52) U.S. Cl. CPC H04L 41/0816; G06F 9/4416; H04L 61/2023

(57) ABSTRACT

A reconfigurable computing device includes an application layer adapted to run a plurality of applications, a configuration layer adapted to configure the applications, and a network layer adapted to provide access to a network for the configuration layer and the application layer. The network layer and the configuration layer are configured as static partitions in a static region of the device. The static partitions and the static region are configured only upon booting the device. The applications are configured as dynamic partitions in a dynamic region of the device and the dynamic partitions and the dynamic region are reconfigurable during operation of the device. A related computer implemented method is also disclosed.

### BACKGROUND

The invention relates to a reconfigurable computing device that can be attached to a network.

In recent years, Field Programmable Gate Array (FPGA) technology continued to grow in importance as one of multiple programmable off-the-shelf accelerator technologies that can be used to improve performance and optimize power for selected application domains. As part of ongoing FPGA developments, the concept of dynamic partial reconfiguration support is gaining attention. The latter allows to reconfigure only selected parts of an FPGA during runtime.

Reconfigurable computing devices, such as FPGAs, are usually used as a co-processor tightly coupled with a server, e.g. over the PCIe bus. This tight-coupling however inhibits the usage of FPGAs in a scalable and a flexible manner.

Accordingly, there is a need for new system architectures for reconfigurable computing devices.

### SUMMARY

According to a first aspect, the invention is embodied as a reconfigurable computing device. The device comprises an application layer adapted to run a plurality of applications, a configuration layer adapted to configure the applications and a network layer adapted to provide access to a network for the configuration layer and the application layer. The network layer and the configuration layer are configured as static partitions in a static region of the device. The static partitions and the static region are configured only upon booting the device. The applications are configured as dynamic partitions in a dynamic region of the device and the dynamic partitions and the dynamic region are reconfigurable during operation of the device.

According to another aspect a computer implemented method for operating a reconfigurable computing device is provided. The reconfigurable computing device comprises an application layer, a configuration layer, a network layer and a memory unit. The method comprises booting the device from a static bit stream stored in the memory unit. Thereby the configuration layer and the network layer are configured as static partition in a static region of the device. The method further comprises configuring, by the configuration layer, applications as dynamic partitions in a dynamic region of the device and running, by the application layer, a plurality of applications. The method further comprises providing, by the network layer, access to a network for the configuration layer and the application layer.

Embodiments of the invention will be described in more detail below, by way of illustrative and non-limiting examples, with reference to the accompanying drawings.

### BRIEF DESCRIPTION OF THE DRAWINGS

FIG. 1 depicts a cloud computing node according to an embodiment of the present invention;

FIG. 2 depicts a cloud computing environment according to an embodiment of the present invention;

FIG. 3 depicts abstraction model layers according to an embodiment of the present invention;

FIG. 4 illustrates a reconfigurable computing device according to an embodiment of the invention;

FIG. 5 illustrates in an exemplary way the storage of a static bit stream in a reconfigurable computing device according to an embodiment of the invention;

FIG. 6 shows a system according to an embodiment of the invention; and

FIG. 7 shows method steps of a computer implemented method for operating a reconfigurable computing device according to an embodiment of the invention.

### DETAILED DESCRIPTION

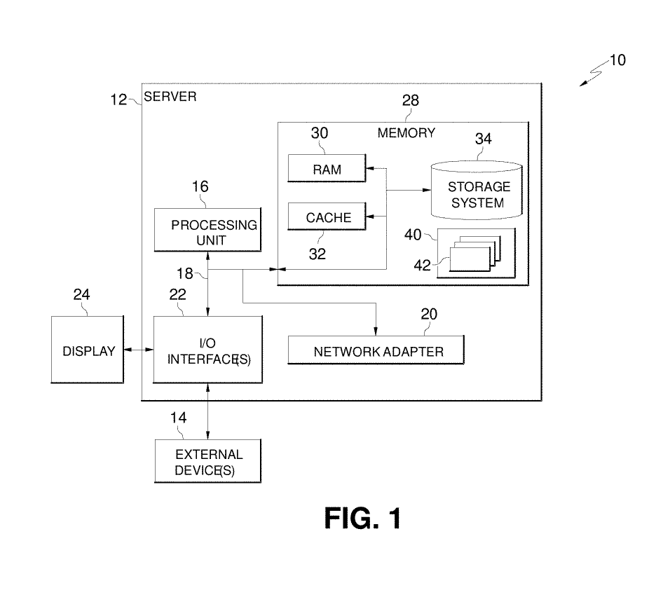

In reference to FIGS. 1-7, some general aspects and terms of embodiments of the invention are described.

In the context of this description, the following conventions, terms and/or expressions may be used:

The term “field programmable gate array” (FPGA) may denote an integrated hardware circuit designed to be configured for one or more computing tasks by a system designer after manufacturing—hence “field-programmable”. The one or more FPGA configurations may be generally specified using a hardware description language (HDL) and may have large resources of logic gates and RAM blocks to implement complex digital computations.

A reconfigurable computing device according to embodiments of the invention may be implemented in particular for applications requiring calculations that are highly repetitive, like, e.g., in Fast Fourier Transformation (FFT) calculations or matrix-vector multiplications. This type of calculations are based on repetitive add/multiply operations.

The term bitstream shall denote “configuration data” that shall be used to configure one or more partitions of a reconfigurable computing device, in particular a FPGA, for a specific function or computing task. The configuration data may be implemented as a horizontal micro-code vector for the setting of multiplexers defining the functionality of the partitions of the reconfigurable computing device. Different bitstreams and different configuration data respectively may result in different functionalities of the one or more partitions of the reconfigurable computing device. It should be noted that the term bitstream shall encompass “serial bitstreams” that are loaded into a reconfigurable device in a serial manner, but also “parallel bitstreams” that are loaded into a reconfigurable device according to parallel loading methods such as byte-parallel loading.

The term “operand data” may denote data that shall be processed by a reconfigurable computing device according to embodiments of the invention.

The term “control information” may denote control information or control data that shall be used to control the operation of the device.

Embodiments of the invention propose an architecture of a reconfigurable computing device which provides a direct network attachment for applications running in an application layer of the device.

According to embodiments of the invention reconfigurable computing devices can be decoupled from any host server. The reconfigurable computing device according to embodiments of the invention can operate as standalone device that can be operated without an external controller. More particularly, the device may be operated as independent self-managed device. The device may have only a single point of attachment to the network and according to embodiments only one physical network connection/network cable is needed to connect the reconfigurable computing device.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a server 12, which is operational with numerous other general purpose or special purpose computing system environments or configurations. Examples of well-known computing systems, environments, and/or configurations that may be suitable for use with server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Server 12 may be described in the general context of computer system-executable instructions, such as program modules, being executed by a computer system. Generally, program modules may include routines, programs, objects, components, logic, data structures, and so on that perform particular tasks or implement particular abstract data types. Server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, server 12 in cloud computing node 10 is shown in the form of a general-purpose computing device. The components of server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Server 12 typically includes a variety of computer system readable media. Such media may be any available media that is accessible by server 12, and it includes both volatile and non-volatile media, removable and non-removable media.

System memory 28 can include computer system readable media in the form of volatile memory, such as random access memory (RAM) 30 and/or cache memory 32. Server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Server 12 may also communicate with one or more external devices 14 such as a keyboard, a pointing device, a display 24, etc.; one or more devices that enable a user to interact with server 12; and/or any devices (e.g., network card, modem, etc.) that enable server 12 to communicate with one or more other computing devices. Such communication can occur via Input/Output (I/O) interfaces 22. Still yet, server 12 can communicate with one or more networks such as a local area network (LAN), a general wide area network (WAN), and/or a public network (e.g., the Internet) via network adapter 20. As depicted, network adapter 20 communicates with the other components of server 12 via bus 18. It should be understood that although not shown, other hardware and/or software components could be used in conjunction with server 12. Examples, include, but are not limited to: microcode, device drivers, redundant processing units, external disk drive arrays, RAID systems, tape drives, and data archival storage systems, etc.

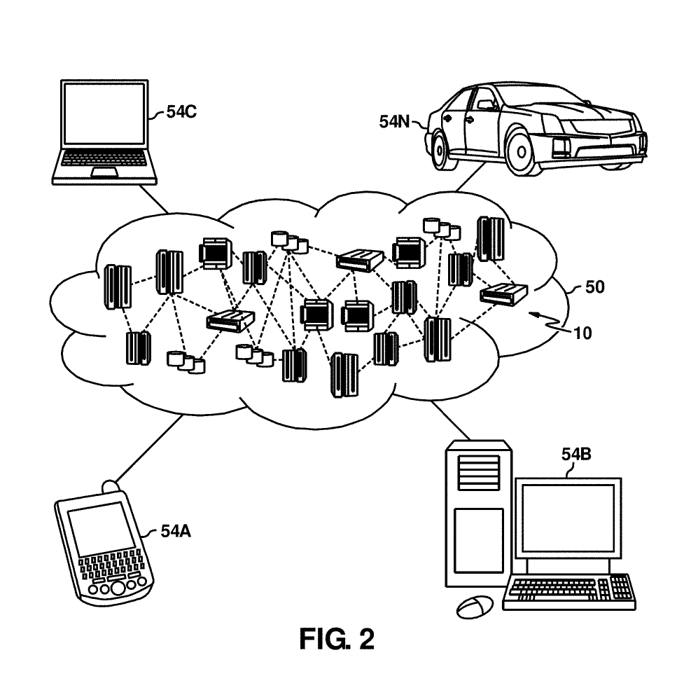

Referring now to FIG. 2, illustrative cloud computing environment 50 is depicted. As shown, cloud computing environment 50 includes one or more cloud computing nodes 10 with which local user devices used by cloud consumers, such as, for example, personal digital assistant (PDA) or cellular telephone 54A, desktop computer 54B, laptop computer 54C, and/or automobile computer system 54N may communicate. The user devices 54A, 54B, 54C and 54N may in the following be also generally referred to as user devices 54. The user devices 54 may belong to the same user or a user group. User devices 54 that belong to the same user or a user group are referred to as set 55 of user devices 54. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

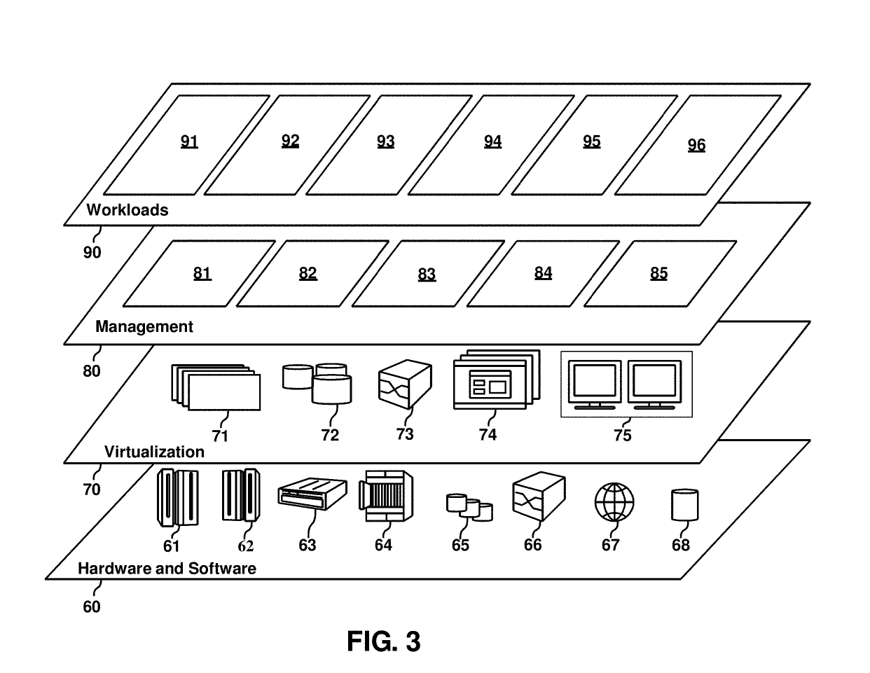

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and repetitive computing tasks such as FFT calculations 96 that are in particular suitable to be performed by reconfigurable computing devices such as FPGAs.

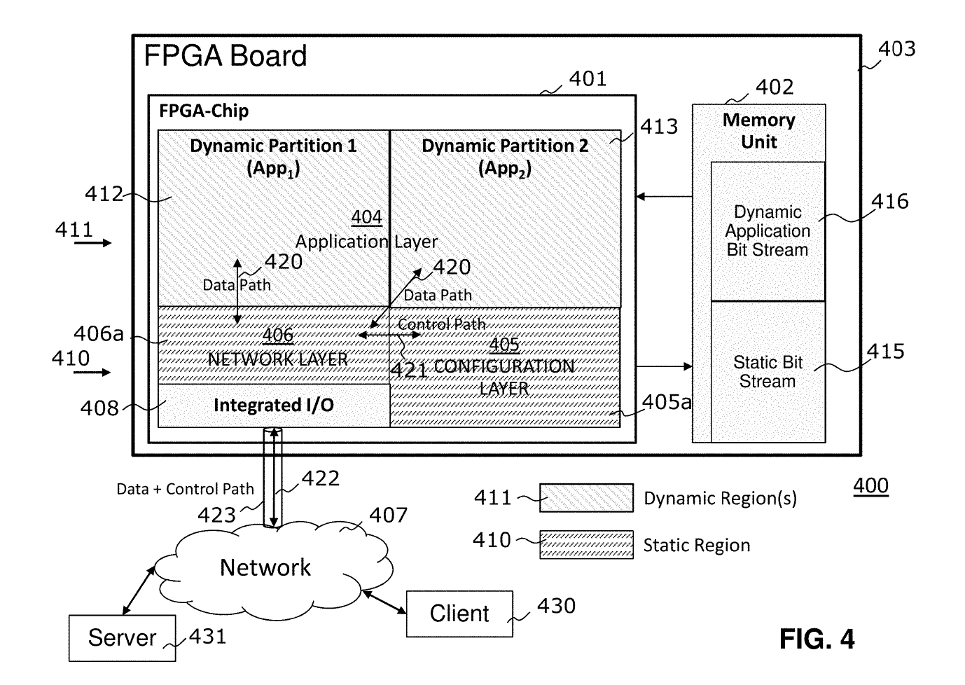

FIG. 4 illustrates a reconfigurable computing device 400 according to an embodiment of the invention. The reconfigurable computing device 400 is embodied as Field Programmable Gate Array (FPGA) and comprises an FPGA-chip 401 and a memory unit 402. The FPGA chip 401 and the memory unit 402 are arranged on a common printed circuit board (PCB) 403. The memory unit 402 may be in particular embodied as Flash-memory.

The FPGA-chip 401 of the reconfigurable computing device 400 comprises an application layer 404 adapted to run a plurality of applications Appᵢ. The applications Appᵢ may be e.g. applications requiring calculations that are highly repetitive, like, e.g., in Fast Fourier Transformation (FFT) calculations or matrix-vector multiplications. The FPGA-chip 401 of the device 400 comprises further a configuration layer 405 that is adapted to configure or program the applications Appᵢ. into the application layer 404. It should be noted that the terms “configuring” and “programming” are generally used in an interchangeable way. The FPGA-chip 401 comprises further a network layer 406 adapted to provide access to a network 407 for the configuration layer 405 and the application layer 406. The FPGA-chip 401 comprises an integrated Input/Output (I/O)-circuit 408 that provides standard hardware circuitry for providing an I/O interface to the network 407. The I/O circuit 408 may encompass e.g. the user pins provided by the FPGA-chip 401.

The network layer 406 is configured as static partition 406a and the configuration layer 405 is configured as static partition 405a. The static partitions 405a and 406a establish a static region 410 of the device 400. The static partitions 406a and 405a and correspondingly the static region 410 are configured only once upon booting the device 400. After the static partitions 405a and 406a have been configured, they remain unchanged during operation of the device 400 at least until the next booting of the device 400. Once configured upon booting, the configuration layer 405 and the network layer 406 provide predefined functionalities for the device 400 which will be explained below in more detail.

The applications Appᵢ are configured as dynamic partitions in a dynamic region 411 of the device 400. In the exemplary embodiment of FIG. 4, a dynamic partition 412 has been configured for an application App₁ and a dynamic partition 413 has been configured for an application App₂ The dynamic region 411 and the dynamic partitions 412, 413 are reconfigurable during operation of the device 400, hence dynamic partitions and dynamic region. More particularly, new applications Appᵢ may be programmed into the dynamic region 411 during operation of the device 400. Furthermore, applications Appᵢ that have already been configured in the dynamic region 411 may be removed from the dynamic region 411 during runtime and replaced with new applications Appᵢ.

The memory unit 402 is provided for storing a static bit stream 415 comprising configuration data to configure the configuration layer 405 and the network layer 406. The static bit stream 415 serves as boot file or boot region for the device 400. More particularly, when the device 400 is booted, e.g. by turning on a power supply for the device 400, the device 400 boots from the static bit stream 415. Thereby the configuration layer 405 and the network layer 406 are configured and programmed respectively in the static region 410 of the device 400. In order to make the device 400 accessible to the network 407, the device 400 may get through the network layer 406 an Internet Protocol (IP address) from a DHCP-server connected to the network 407. In order to request the IP address, the device 400 sends its MAC address to the DHCP-server. The MAC address of the device 400 may be stored e.g. in a small read only memory of the device 400, e.g. during manufacturing of the device 400. According to another embodiment the static bit stream may comprise the MAC-address of the device 400.

The memory unit 402 is further provided for storing application bit streams 416 in the memory unit 402. The application bit streams 416 comprise configuration data to configure one or more applications Appᵢ. According to some embodiments one or more application bit streams 416 may be stored e.g. permanently as standard application bit streams in the memory unit 402. These permanently stored application bit streams 416 may store e.g. configuration data for applications that are often or regularly used. According to other embodiments application bit streams may be received during the operation of the device 400 from the network 407 via the network layer 406. The application bit streams received from the network 407 may be either configured directly by the configuration layer 405 into the application layer 404 or they may be first stored in the memory unit 402 and then programmed from the memory unit 402 by the configuration layer 405 into the application layer 404. In this respect the configuration layer 405 serves as control unit/controller for controlling the programming of the respective application bit stream into the application layer 404. To enable network access to the respective application Appᵢ, the configuration layer 405 also configures address information for the applications Appᵢ into the network layer 406. More particularly, the configuration layer 405 configures according to embodiments an Internet Protocol (IP) address and a Media Access Control (MAC) address for the applications Appᵢ into the network layer 406.

As illustrated in FIG. 4 with arrows, as a result of the configuration the device 400 comprises a data path 420 between the network layer 406 and the application layer 404. The data path 420 is provided for transferring operand data between the network layer 406 and the application layer 404. The operand data may be e.g. data that has been received via the network layer 406 from the network 407 and that shall be processed by one of the applications Appᵢ of the reconfigurable computing device 400. As an example, if an application Appᵢ is an application for performing a FFT-calculation, the operand data is the input data for the FFT calculation received from the network 407. The operand data may be e.g. sent from a client computer 430 or a server computer 431 coupled to the network 407. This enables the client computer 430 and/or the server computer 431 to use the processing resources of the device 400.

Furthermore, the application layer 404 provides a control path 421 between the network layer 406 and the configuration layer 405. The control path 421 is provided for transferring control information between the network layer 406 and the configuration layer 405. The control information is information or data that is used to control the operation of the device 400 and in particular to program or configure applications Appᵢ into the application layer 404. The control information also encompasses application bitstreams that have been received via the network layer 406 from the network 407 and that shall be programmed into the application layer 404 and/or stored in the memory unit 402.

In addition, a shared control/data path 422 is provided, via the integrated I/O circuit 408, between the network layer 406 and the network 407. The shared control/data path 422 is provided for transferring operand data and control information between the network layer 406 and the network 407. This shared control/data path 422 combines the operand data transmitted between the network layer 406 and the application layer 404 via the data path 420 and the control information transmitted between the network layer 406 and the configuration layer 405 via the control path 421. The shared control/data path 422 enables the device 400 to communicate with the network 407 via a single physical data connection 423 provided between the integrated I/O circuit 408 and the network 407. The single physical data connection 423 may be e.g. a single cable such as an Ethernet-cable that is plugged into a connector of the integrated I/O circuit 408.

The device 400 may be used to provide computing services in a cloud environment via the network 407 to a plurality of client computers 430 and/or server computers 431 connected to the network 407.

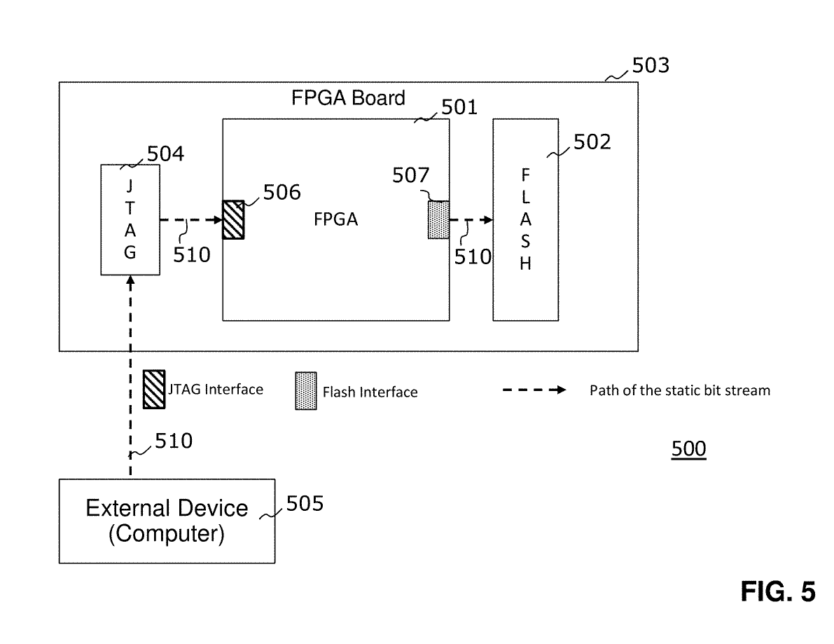

FIG. 5 illustrates in an exemplary way the storage of a static bit stream in a reconfigurable computing device 500 according to an embodiment of the invention. The reconfigurable computing device 500 is also embodied as Field Programmable Gate Array (FPGA) and comprises an FPGA-chip 501 and a memory unit 502 that is embodied as flash-memory. The FPGA chip 501 and the memory unit 502 are arranged on a common printed circuit board (PCB) 503, also denoted as FPGA board 503. The FPGA board 503 comprises a JTAG-port 504 that is embodied according to the Joint Test Action Group (JTAG) standard. The JTAG-port 504 provides connection pins for external devices 505 such as client computers or server computers to connect with the FPGA board 503. The FPGA-chip 501 comprises a JTAG-interface 506 to connect the FPGA-chip 501 with the he JTAG-port 504 and a flash-interface 507 to connect the FPGA-chip 501 with the memory unit 502. A path 510 for storing a static bit stream in the memory unit 502 is illustrated with dotted lines. More particularly, the static bit stream is sent from the external device 505 to the JTAG-port 504, then to the JTAG-interface 506 and via the flash-interface 507 to the memory unit 502.

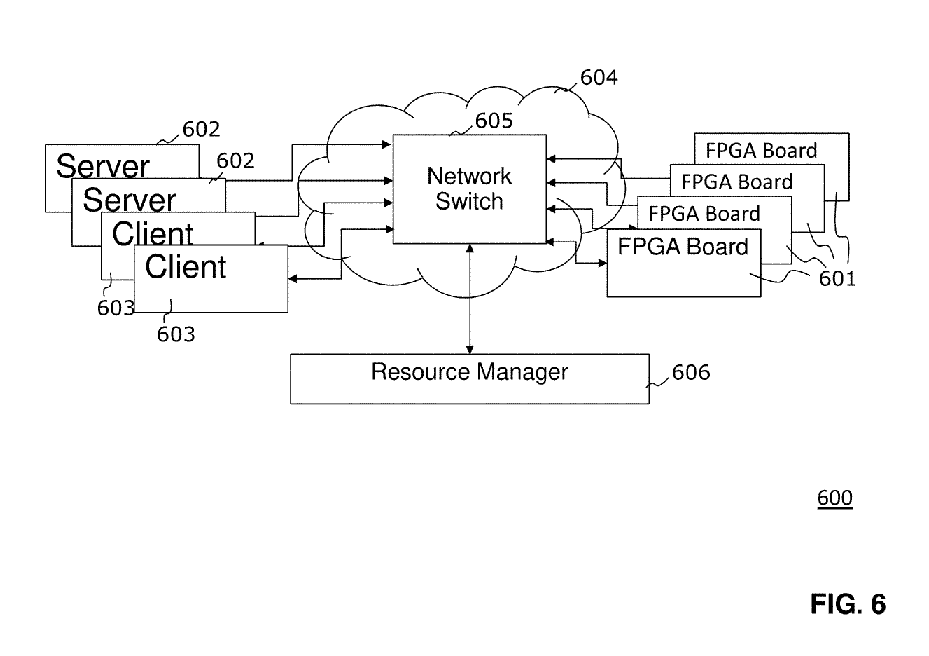

FIG. 6 shows a system 600 according to an embodiment of the invention. The system 600 comprises as reconfigurable computing devices a plurality of FPGA boards 601. The FPGA boards 601 may be e.g. embodied like the PCBs 403 as described with reference to FIG. 4. The system 600 comprises furthermore a plurality of server computers 602 and a plurality of client computers 603. The server computers 602, the client computers 603 and the FPGA boards 601 are all connected to a network 604 and may communicate with each other over the network 604. In order to facilitate the communication between the server computers 602, the client computers 603 and the FPGA boards 601, a central network switch 605 is provided. The central network switch 605 is controlled by a resource manager 606 which serves as resource manager for the server computers 602, the client computers 603 and the FPGA boards 601. The resource manager 606 is in particular configured to manage the connections between the server computers 602, the client computers 603 and the FPGA boards 601 and to arrange IP-addresses and MAC-addresses for them. The IP-addresses and MAC-addresses provided by the resource manager 606 may be in particular virtual addresses. Accordingly the IP-addresses and MAC-addresses that the configuration layer configures into the network layer for the respective applications that run in the application layer may also be embodied as virtual IP-addresses and virtual MAC-addresses. More particularly, the configuration layer of the respective FPGA-board 601 may receive a virtual IP-address and a virtual MAC-address for a new application that shall be configured from the resource manager 606 and configure this received virtual IP-address and MAC-address into the network layer 406.

The server computers 602 may be embodied e.g. as the server 12 as described with reference to FIG. 1. According to embodiments the server computers 602 may establish a cloud computing node for the client computers 603. According to such a cloud embodiment the server computers 602 may offer computing services in a cloud environment to the client computers 603. According to such a cloud embodiment, the server computers 602 may utilize the FPGA-boards 601 to perform special and in particular highly-repetitive computing tasks such as FFT-computations or matrix-vector multiplications.

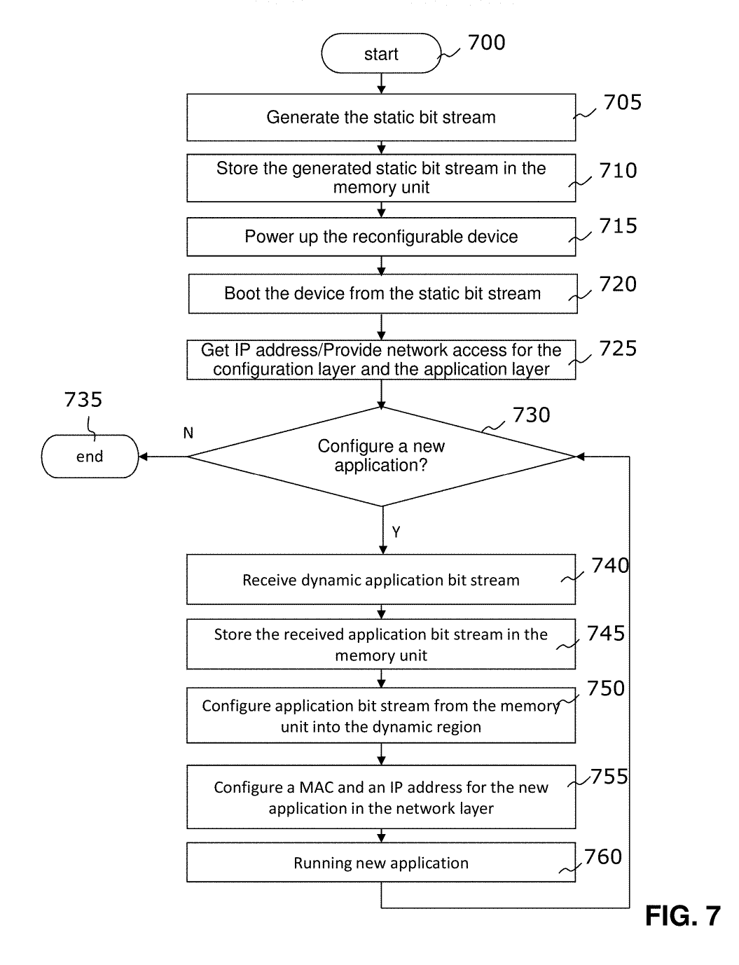

FIG. 7 shows method steps of a computer implemented method for operating a reconfigurable computing device, e.g. the device 400 as described with reference to FIG. 4.

At a step 700, the method is started.

At a step 705, a static bit stream is generated. The static bit stream comprises configuration data for configuring the configuration layer 405 and the network layer 406.

At a step 710, the generated static bit stream is stored in the memory unit 402 of the device 400.

The steps 710 and 715 may be e.g. performed by the provider of the devices 400. By storing the static bit stream in the memory unit 402 of the device, the device 400 has been prepared/initialized to act as standalone reconfigurable device that can be attached to a network.

At a step 720, the device 400 is booted from the static bit stream that is stored in the memory unit 402. During the booting step 420, the configuration layer 405 and the network layer 406 are configured as a static partition in the static region 410 of the device 400.

At a step 725, the device 400 gets an IP-address, e.g. from a DHCP-server, through the network layer 406. Accordingly the network layer 406 provides then access to the network 407 for the configuration layer 405 and the application layer 404. This allows external devices of the network 407, e.g. the server computers 431 or the client computers 430, to communicate with the device 400 and to use the device 400 to perform computing tasks.

At a step 730, it is checked whether a new application shall be configured. Otherwise the method stops in a step 735 for the time being. If a new application shall be configured, the configuration layer receives in a step 740 an application bit stream via the network layer 406 from the network 407. In a step 745 the configuration layer 405 stores the received application bit stream in the memory unit 402. At a step 750, the configuration layer 405 configures or programs the application bit stream into the dynamic region 411 of the device 400. For this, the configuration layer 405 may request the memory unit 402 to program the application bit stream into the dynamic region 411. According to other embodiments the configuration layer 405 may configure the received application bit stream directly into the dynamic region 411 of the device 400.

At a step 755, the configuration layer 405 configures address information for the respective application into the network layer 406. This may include configuring an Internet Protocol (IP) address and a Media Access Control (MAC) address for the application into the network layer 406. The IP-address and the MAC-address may be in particular virtual addresses that the configuration layer 405 receives from the resource manager 606 as described with reference to FIG. 6.

As a result, the respective application has been fully configured in the application layer 404 and can be accessed via the network layer 406 from devices connected to the network 407. Accordingly in a step 760 the newly configured application is running in the application layer 404.

During operation of the device 400 other new applications may be configured at runtime in the dynamic region 411. For this, the steps 730-760 as described above may be repeated.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A reconfigurable computing device comprising
an application layer adapted to run a plurality of applications;
a configuration layer adapted to configure the applications;
a network layer adapted to provide access to a network for the configuration layer and the application layer;
wherein
the network layer and the configuration layer are configured as static partitions in a static region of the device, the static partitions and the static region being configured only upon booting the device; and
the applications are configured as dynamic partitions in a dynamic region of the device, the dynamic partitions and the dynamic region being reconfigurable during operation of the device.

2. The computing device according to claim 1, wherein the device comprises a memory unit and wherein the device is adapted to:
store a static bit stream in the memory unit, the static bit stream comprising configuration data to configure the configuration layer and the network layer; and
boot the device from the static bit stream of the memory unit, thereby configuring the configuration layer and the network layer in the static region of the device.

3. The computing device according to claim 1, wherein the device comprises a memory unit and wherein the device is adapted to:
store one or more application bit streams in the memory unit, the application bit streams comprising configuration data to configure one or more applications;
configure the application bit streams from the memory unit into the dynamic region of the device.

4. The computing device according to claim 1, wherein the configuration layer is adapted to:
receive an application bit stream via the network layer from the network, the application bit stream comprising configuration data to configure one or more applications; and
configure the received application bit stream in the dynamic region of the device.

5. The computing device according to claim 1, wherein the configuration layer is adapted to
configure address information of the applications into the network layer.

6. The computing device according to claim 5, wherein the configuration layer is adapted to
configure an Internet Protocol (IP) address and a Media Access Control (MAC) address for the applications into the network layer.

7. The computing device according to claim 1, wherein the network layer is adapted to
provide a data path for transferring operand data between the network layer and the application layer;
provide a control path for transferring control information between the network layer and the configuration layer; and
provide a shared control/data path for transferring operand data and control information between the network layer and the network.

8. The computing device according to claim 1, wherein the computing device is adapted to communicate with the network via a single physical data connection.

9. The computing device according to claim 1, wherein the computing device is a field programmable gate array (FPGA).

10. The computing device according to claim 1, wherein the memory device is a flash memory device.

11. The computing device according to claim 1, wherein to device is adapted to provide computing services in a cloud environment.

12. A system comprising
a plurality of reconfigurable computing devices, each in turn comprising:
an application layer adapted to run a plurality of applications;
a configuration layer adapted to configure the applications;
a network layer adapted to provide access to a network for the configuration layer and the application layer;
wherein
the network layer and the configuration layer are configured as static partitions in a static region of the device, the static partitions and the static region being configured only upon booting the device; and
the applications are configured as dynamic partitions in a dynamic region of the device, the dynamic partitions and the dynamic region being reconfigurable during operation of the device;
a plurality of server computers and/or client computers;
a network;
a network switch configured to arrange network connections for the devices, the server computers and/or the client computers;
a resource manager configured to
control the network switch; and
manage the network connections for the devices, the server computers and/or the client computers.

13. A computer implemented method for operating a reconfigurable computing device, the reconfigurable computing device comprising an application layer, a configuration layer, a network layer and a memory unit, the method comprising:
booting the device from a static bit stream stored in the memory unit, thereby configuring the configuration layer and the network layer as static partition in a static region of the device;
configuring, by the configuration layer, applications as dynamic partitions in a dynamic region of the device;
running, by the application layer, a plurality of applications;
providing, by the network layer, access to a network for the configuration layer and the application layer.

14. The computer implemented method according to claim 13, further comprising:
storing an application bit stream to configure an application in the memory unit; and
configuring the application bit stream from the memory unit into the dynamic region of the device.

15. The computer implemented method according to claim 13, further comprising
receiving, by the configuration layer, an application bit stream via the network layer from the network; and
configuring, by the configuration layer, the application bit stream into the dynamic region of the device.

16. The computer implemented method according to claim 13, further comprising
configuring, by the configuration layer, address information of the application into the network layer.

17. The computer implemented method according to claim 16, further comprising
configuring, by the configuration layer, an Internet Protocol (IP) address and a Media Access Control (MAC) address for the applications into the network layer.

18. The computer implemented method according to claim 13, further comprising
providing a data path for transferring operand data between the network layer and the application layer;
providing a control path for transferring control information between the network layer and the configuration layer; and
providing a shared control/data path for transferring operand data and control information between the network layer and the network.

19. The computer implemented method according to claim 13, the method providing computing services in a cloud environment.

20. The computer implemented method according to claim 13, further comprising
performing a communication between the computing device and the network via a single physical data connection.
